(19) United States
(12) Patent Application Publication
(10) Pub. No.: US 2012/0012761 A1
(43) Pub. Date: Jan. 19, 2012

(54) HIGH-POWER PULSE-SIGNAL RADIATION SYSTEM

(75) Inventors: Seung Kab Ryu, Daejeon (KR); Kyung Hoon Lee, Daejeon (KR)

(73) Assignee: ELECTRONICS AND TELECOMMUNICATIONS RESEARCH INSTITUTE, Dejeon (KR)

(21) Appl. No.: 13/167,851

(22) Filed: Jun. 24, 2011

(30) Foreign Application Priority Data
Jul. 15, 2010 (KR) 10-2010-0068197

(51) Int. Cl. G21K 5/00

(52) U.S. Cl. 250/493.1

(57) ABSTRACT

Provided is a high-power pulse-signal radiation system. The system includes a pulse generating unit, a pulse radiation unit, a remote control unit, and a photoelectric conversion unit. The pulse generating unit use a DC power supply as a primary source, generate a pulse signal, and transmit a pulse signal to a radiation unit of an antenna through a high power coaxial cable. The pulse radiation unit receives the pulse signal generated by the pulse generating unit and radiates pulse energy corresponding to the pulse signal in a space. The remote control unit transmits an electric control signal required for controlling operation of the pulse generating unit.

### CROSS-REFERENCE TO RELATED APPLICATION

This application claims priority to and the benefit of Korean Patent Application No. 10-2010-0068197, filed Jul. 15, 2010, the disclosure of which is incorporated herein by reference in its entirety.

### BACKGROUND

1. Field of the Invention

The present invention relates to a high voltage fast transient pulse radiating system and, more particularly, to a high peak power pulse radiating system, which may generate a high peak power pulse signal, and be controlled and managed in real time at a remote place for ensuring users' safety.

2. Discussion of Related Art

In recent years, pulse signal generators capable of generating high-peak-power fast transient pulse signals have been developed for various purposes.

In general, a pulse signal generator may have a frequency bandwidth of several hundred MHz to several GHz and generate a pulse signal having a peak power of several tens of MW or higher. In this case, designing a shielding structure of a digital control printed-circuit-hoard (PCB) included in the pulse signal generator may be important. Also, the PCB circuit may be installed at a spot where the influence of an internal electromagnetic-interference (EMI) radiation source is minimized, so that a digital control circuit, which is driven at a transistor-transistor-logic (TTL) level of about 5 V, can operate normally.

FIG. 1A is a circuit diagram of a conventional inductive-energy-storage-type high-speed pulse generating unit.

Referring to FIG. 1A, the conventional high-speed pulse generating unit may include a capacitor C₁ in which input power is charged, an inductor L₁ and a thyristor X₁ configured to charge the capacitor C₁ with the input power, a thyristor X₂ configured to transmit energy charged in the capacitor C₁ to a pulse transformer PT₁, the pulse transformer PT₁ configured to function as both a transformer and a magnetic switch and boost the energy charged in the capacitor C₁, a capacitor C₂ in which the boosted energy is charged, a plurality of diodes D, configured to function as diodes when the capacitor C₂ is charged and function as opening switches when the charged energy of C₂ is discharged from the capacitor C₂, and a load unit R_{LOAD}.

Since the high-speed pulse generating unit is used to apply driving power to a high-speed plasma power supply apparatus, the high-speed pulse generating unit may be embodied without consideration of an output impedance characteristic according to compatibility with an antenna required for radiating energy or of pulse variability, repetition number and rate of an output pulse, or an operation mode, such as a pulse combination.

Meanwhile, FIG. 1B is a construction diagram of a conventional rock blasting apparatus using electric energy.

Referring to FIG. 1B, the conventional rock blasting apparatus may include a capacitor bank 112 configured to store a power supply voltage applied from a power supply unit 111, a switching unit 113, a trigger unit 114 configured to drive the switching unit 113, a trigger signal generator 115 connected to the trigger unit 114 through an optical cable and configured to drive the trigger unit 114 in a remote place, and a coaxial power cable 117 configured to transmit an electric energy to a blasting electrode 116 according to operation of the switching unit 113.

The rock blasting apparatus of FIG. 1B may ensure users' safety because the trigger signal generator 115 configured to generate a trigger signal for controlling the operation of the apparatus is far apart from the remaining portion of the apparatus. However, the rock blasting apparatus of FIG. 1B may be provided in disregard of control of radiation electric-field intensity and frequency required by a pulse generating unit, confirmation of a connection state of the apparatus, output-signal monitoring, and control of a peak voltage of an output pulse signal. Also, since the rock blasting apparatus of FIG. 1B is a conductive energy transmitting apparatus, a portion that is compatible with an antenna required for radiating pulse energy may not be embodied.

Meanwhile, FIG. 1C is a block diagram of a conventional portable pulse generating unit configured to stop the function of a vehicle using an antenna in a remote place.

Referring to FIG. 1C, the conventional portable pulse generating unit may include a power source 121 configured to supply a power supply voltage of about 12 V and a control trigger signal, a power controller 122 configured to control the power supply voltage supplied from the power source 121, a pulse generator 124 configured to convert the power supply voltage into a pulse signal having a peak voltage of about 20 to 50 kV and a width of about 5 μs in response to a trigger signal received from a controller 123, an oscillator 126 configured to oscillate in response to the trigger signal received from a trigger signal generator 125 and generate a square-wave pulse signal with a pulse of several ns, and a radiator 127 configured to receive square waves from the oscillator 126 and radiate energy in a predetermined space. Meanwhile, the controller 123 may remove the influence of the entire portable pulse generating unit on the human body and transmit a user authentication signal and a safety signal to the power controller 122 to prevent use of the portable pulse generating unit with bad intentions.

Although misuse of the above-described apparatus may be prevented, the user should control operation of the apparatus near the apparatus, thus precluding ensuring the user's safety.

Accordingly, it is urgently necessary to develop a pulse generation/radiation apparatus capable of precisely controlling an output pulse signal and ensuring the user's safety.

### SUMMARY OF THE INVENTION

The present invention is directed to a high-power pulse-signal radiation system, which may allow a user to control an operation of outputting a pulse signal in a remote place so that the pulse signal can be precisely output according to desired parameters and users can be safely protected from high electric-field-intensity environments.

One aspect of the present invention provides a high-power pulse-signal radiation system including: a pulse generating unit configured to receive a power supply voltage, generate a pulse signal, divide a voltage of the generated pulse signal, and transmit a pulse signal having a divided voltage; a pulse radiation unit configured to receive the pulse signal generated by the pulse generating unit and radiate pulse energy corresponding to the pulse signal in a space; a remote control unit configured to transmit an electric control signal required for controlling operation of the pulse generating unit, receive the pulse signal having the divided voltage, and monitor a state of the pulse generating unit in real time; and a photoelectric conversion unit configured to convert the electric control signal transmitted from the remote control unit into an optical control signal and transmit the optical control signal to the pulse generating unit.

The remote control unit may include: a control mode selector configured to select a mode of controlling the pulse generating unit; and an output mode setter configured to set a waveform of the pulse signal generated by the pulse generating unit.

The control mode selector may select one of a local control mode in which the pulse generating unit is locally controlled, a remote control mode in which the pulse generating unit is remote-controlled by the remote control unit, and an external control mode in which the pulse generating unit is controlled in response to an externally applied trigger signal and output a pulse signal in synchronization with the trigger signal according to a user's input.

The output mode setter may select one of a single output mode in which the pulse generating unit outputs a single pulse signal, an arbitrary output mode in which the pulse generating unit outputs a pulse signal corresponding to a parameter set by a user, and a sequential output mode in which the pulse generating unit outputs a series of pulse signals according to a pulse repetition frequency (PRI') until a stop command is input, according to a user's input.

The remote control unit may further include a parameter setter configured to set the parameter of the pulse signal output by the pulse generating unit according to the user's input when the arbitrary output mode is selected by the output mode setter.

The parameter may include at least one selected from the group consisting of a PRF, a pulse duration time, a pulse stop time, and a pulse repetition number.

The remote control unit may display the divided pulse signal using an oscilloscope in real time.

The pulse generating unit may include: a pulse generator configured to receive the power supply voltage and generate the pulse signal; and an interface provider configured to provide an interface that allows a user to input a control command to control the operation of the pulse generator.

The pulse generating unit may display an operation state and a state of communication between the pulse generating unit and the remote control unit in real time.

The pulse radiation unit may include: a radiator configured to radiate the pulse energy; and a coaxial feeding transmission line.

The radiator may include a horn antenna in which an end of a waveguide expands in a trumpet shape.

The pulse generating unit and the pulse radiation unit may be contained in an anechoic chamber consisting of an absorbing material capable of minimizing electromagnetic scattering characteristics is formed, and the pulse generating unit may be contained in a shield-rack configured to cut off electromagnetic waves.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1A is a circuit diagram of a conventional inductive-energy-storage-type high-speed pulse generating unit;

FIG. 1B is a construction diagram of a conventional apparatus of blasting a rock using electric energy;

FIG. 1C is a block diagram of a conventional portable pulse generating unit;

FIG. 2 is a construction diagram of a high-power pulse-signal radiation system according to an exemplary embodiment of the present invention;

FIG. 3 is a diagram of an embodied example of a high-power pulse-signal radiation system according to an exemplary embodiment of the present invention;

FIG. 4 is a block diagram of a remote control unit according to an exemplary embodiment of the present invention;

FIG. 5 is a diagram of an example of a user interface provided by the remote control unit according to an exemplary embodiment of the present invention;

FIG. 6 is a diagram of an example of the waveform of a pulse signal divided by a pulse generating unit and displayed using a remote control unit, according to an exemplary embodiment of the present invention;

FIG. 7 is a flowchart illustrating a process of controlling the output of a pulse signal in a pulse generating unit according to an exemplary embodiment of the present invention;

FIGS. 8A and 8B are flowcharts of an operation of a display unit included in a pulse generating unit according to an exemplary embodiment of the present invention;

FIGS. 9A through 9C are flowcharts of an operation of processing input/output values in a pulse generating unit according to an exemplary embodiment of the present invention;

FIG. 10 is a flowchart of a process of performing an operation corresponding to an input key in a display unit included in a pulse generating unit according to an exemplary embodiment of the present invention; and

FIG. 11 is a flowchart of a process of controlling communication between a pulse generating unit and a remote control unit according to an exemplary embodiment of the present invention.

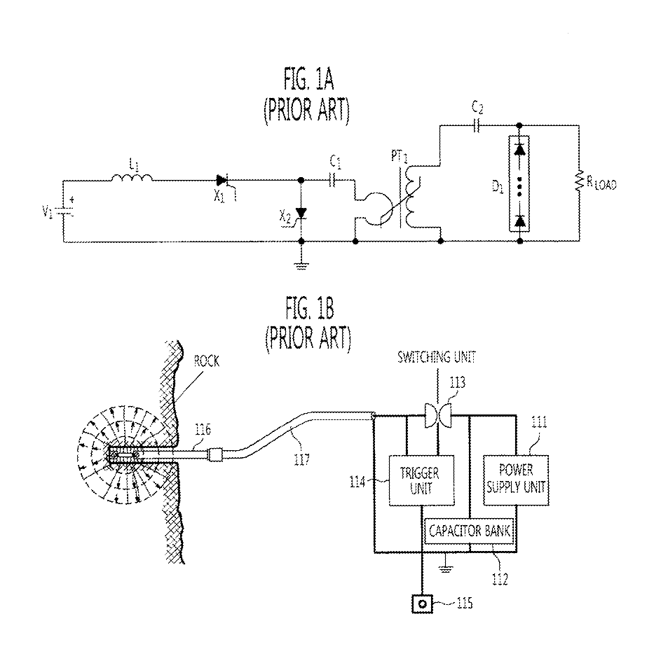

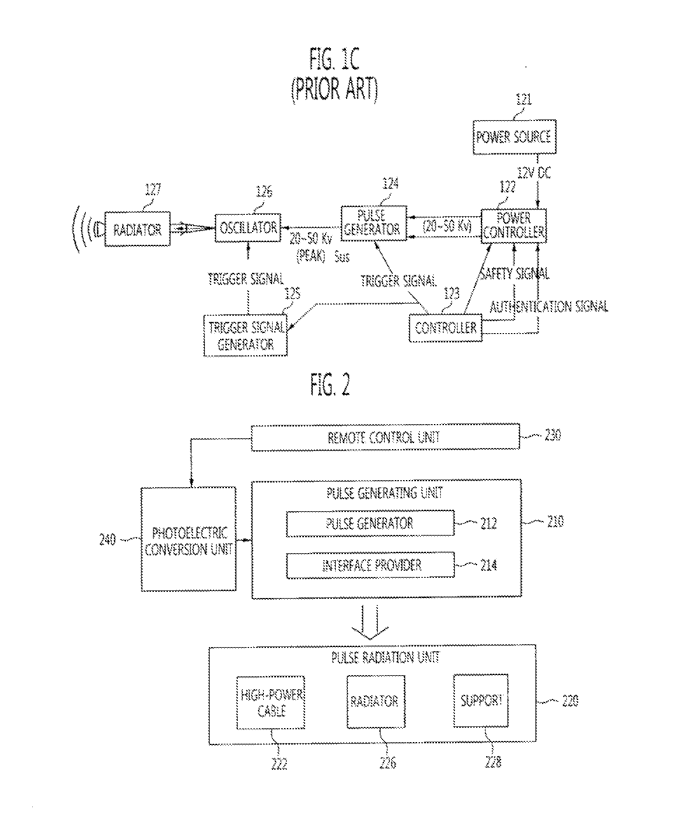

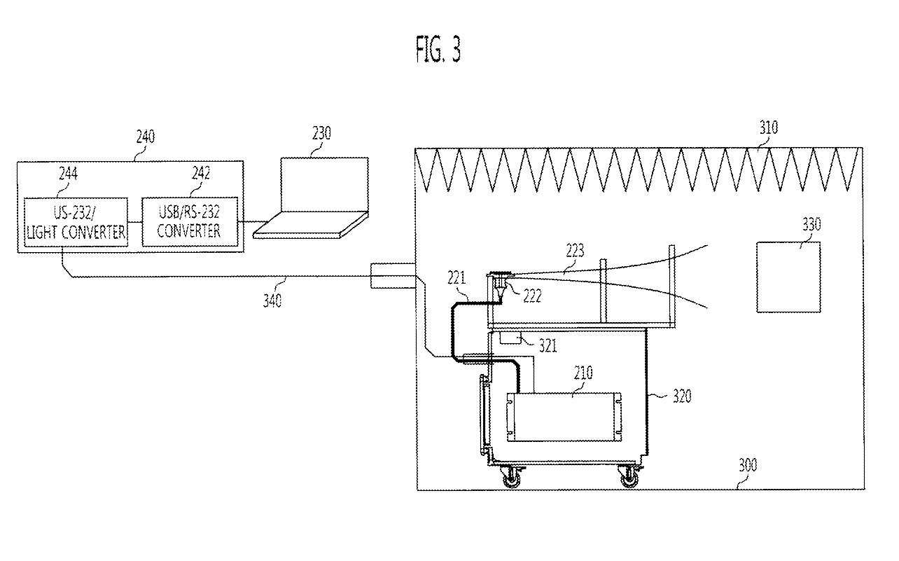

### DETAILED DESCRIPTION OF EMBODIMENTS

The present invention will now be described more fully hereinafter with reference to the accompanying drawings, in which exemplary embodiments of the invention are shown. These embodiments are provided so that this disclosure is thorough and complete and fully conveys the concept of the invention to those skilled in the art. It will be understood that the embodiments are different but not mutually exclusive. For example, specific shapes, structures, and features described therein may be embodied in different forms without departing from the spirit and scope of the invention. Also, it will be understood that positions or arrangements of discrete components in the respective embodiments may be changed without departing the spirit and scope of the invention. Thus, this invention should not be construed as being limited to the embodiments set forth therein, and the scope of the invention may be limited by the appended claims and all equivalents thereof if appropriately described. In the drawings, like reference numerals refer to the same or similar functions in various aspects.

### Embodiment

### Construction of the Entire System

FIG. 2 is a construction diagram of a high-peak-power pulse-signal radiation system capable of control operations in a remote place according to an exemplary embodiment of the present invention.

Referring to FIG. 2, the high-peak-power pulse-signal radiation system according to the exemplary embodiment of the present invention may include a pulse generating unit 210, a pulse radiation unit 220, a remote control unit 230, and a photoelectric conversion unit 240. The pulse generating unit 210 may use a DC power supply as a primary source, generate a pulse signal, and transmit the pulse signal to a radiation unit of an antenna through a high power coaxial cable. Radiation unit 220 may receive the pulse signal generated by the pulse generating unit 210 and radiate pulse energy corresponding to the pulse signal to an aerospace. The remote control unit 230 may transmit an electric control signal required for controlling operation of the pulse generating unit 210. The photoelectric conversion unit 240 may convert the electric control signal received from the remote control unit 230 into an optical control signal and transmit the optical control signal to the pulse generating unit 210.

Referring to FIG. 2, the pulse generating unit 210 according to an exemplary embodiment may include a pulse generator 212 and an interface provider 214. The pulse generator 212 may use a DC power supply as a primary source and generate a pulse signal. The interface provider 214 may provide an interlace to allow a user to input a control command required for controlling the operation of the pulse generator 212.

The pulse generator according to an exemplary embodiment may convert alternating-current (AC) power applied as the power supply voltage into direct-current (DC) power, convert the DC power into the pulse signal, and compress the width of the pulse signal. To do this, the pulse generator 212 may include a rectifier circuit configured to convert the AC power into the DC power, a pulse conversion circuit configured to convert the DC power into the pulse signal, and a predetermined pulse signal compression circuit configured to compress the width of the pulse signal. According to an exemplary embodiment, the pulse generator 212 may receive an AC power of about 220 V and an ultra-wideband fast transient pulse signal having a peak voltage of several tens of kV and a rise time of several ns or less. As the width of the pulse signal output by the pulse generator 212 is compressed, the frequency spectrum of the pulse signal transmitted to the pulse radiation unit 220 may be increased. As described later, the pulse radiation unit 220 may include a radiator 226 having a predetermined shape. The size of the radiator 226 may be proportional to a reciprocal of the frequency of the transmitted pulse signal. By increasing the frequency of the transmitted pulse signal, the radiator 226 may be downsized. Thus, the entire system may also be downscaled.

The interface provider 214 according to an exemplary embodiment may provide an interface to allow a user to input a command for controlling operation of the pulse generator 212 in the pulse generating unit 210. As described below, operation of the pulse generating unit 210 may be controlled in a remote control mode and a local control mode. When the local control mode in which the pulse generating unit 210 is locally controlled is selected, the interface provider may provide a user interface to allow the user to input an operation control command. The user may control the operation of the pulse generator 212 included in the pulse generating unit 210 using the remote control unit 230. In this case, the user may control the operation of the pulse generator 212 in the same manner using the user interface provided by the interface provider 214. The user interface may be provided by the interface provider 214 to the user through a display unit, such as a liquid crystal display (LCD) or a light emitting diode (LED). An operation state of the pulse generating unit 210 or a state of communication between the pulse generating unit 210 and the remote control unit 230 may be displayed on the display unit in real time. Thus, the user may monitor the operation state of the pulse generating unit 210 or the state of communication between the pulse generating unit 210 and the remote control unit 230 in real time.

Meanwhile, the pulse generating unit 210 may further include a keypad to allow the user to input a desired command. The keypad may have a typical shape, for example, the keypad may be a mechanical keypad or a touch-screen-type keypad. Meanwhile, the keypad may be included in the interface provided by the interface provider 214. The keypad may include an “execution” key configured to execute commands, a “stop” key configured to stop operations, a “set” key configured to set an operation mode or parameter of the pulse generating unit 210, and “up” and “down” keys configured to move a cursor on the provided interface.

The pulse radiation unit 220 according to an exemplary embodiment may function to radiate pulse energy corresponding to the pulse signal generated by the pulse generating unit 210 in a predetermined space.

Referring to FIG. 2, the pulse radiation unit 220 may include a high-power cable 222, a radiator 226, and a support 228.

The pulse signal output by the pulse generating unit 210 may be applied to radiator 226 through the high-power cable 222. The high-power cable 222 may have a predetermined impedance.

The radiator 226 may be embodied as a horn antenna in which the end of a waveguide expands in a horn shape to directly radiate the pulse signal in the space. When the remaining oscillation occurs due to the input of the pulse signal in one end of the waveguide, energy of the remaining oscillation may be propagated through the waveguide and radiated through an open end of the waveguide. In this case, since the waveguide is not impedance-matched with the space, part of the energy may be reflected so that all the energy cannot be radiated in the space. When the radiator 226 is embodied as the horn antenna, an opening of the waveguide through which the energy is radiated may gradually expand so that the waveguide can be impedance-matched with the space and the pulse signal can be radiated without energy loss. According to an exemplary embodiment, the radiator 226 may receive a pulse signal having a width of several ns or less from the pulse generating unit 210 and radiate radio waves with a gain of several dBi. Meanwhile, the support 228 may support the radiator 226.

The remote control unit 230 according to an exemplary embodiment may allow the user to control the operation of the pulse generating unit 210 in real time in a remote place far apart from the pulse generating unit 210 and monitor a state of the pulse generating unit 210 in real time based on the pulse signal divided by the pulse generating unit 210. A construction and operation of the remote control unit 230 will be described in detail later.

The photoelectric conversion unit 240 according to an exemplary embodiment may convert an electric control signal transmitted from the remote control unit 230 into an optical control signal and transmit the optical control signal to the pulse generating unit 210. The remote control unit 230 and the pulse generating unit 210 may be disposed far apart from each other. Since the electric control signal output by the remote control unit 230 is converted into the optical control signal by the photoelectric conversion unit 240 and transmitted to the pulse generating unit 210 through an optical cable, the optical control signal may be transmitted at high speed, thereby preventing degradation of a data transmission rate due to a great distance between the remote control unit 230 and the pulse generating unit 210.

### Embodied Examples

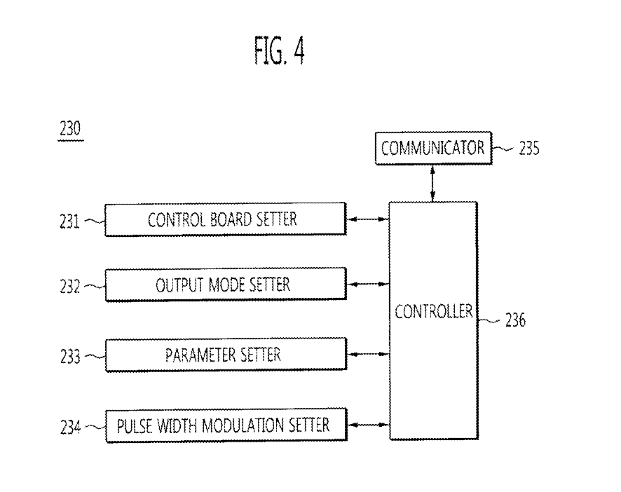

FIG. 3 is a diagram of an embodied example of a high-power pulse-signal radiation system according to an exemplary embodiment of the present invention.

Referring to FIG. 3, the pulse generating unit 210 and the pulse radiation unit 220 may be contained in an anechoic chamber 300. An absorbing material 310, which may have electromagnetic shielding performance and minimize internal electromagnetic scattering characteristics, may be formed on an inner wall of the anechoic chamber 300. Meanwhile, the pulse generating unit 210 may be surrounded with a shielding unit 320. To obtain precise measurement of energy radiated by the pulse radiation unit 220, energy radiated by other components than the pulse radiation unit 220 may be cut off. Thus, the pulse generating unit 210 may be externally shielded by a shielding unit 320. According to an exemplary embodiment, the shielding unit 320 may be formed of a material capable of shielding energy of about several tens of “dB” or more. The shielding unit 320 may include a predetermined filter 321 configured to prevent high-power radiation energy generated therein from being supplied to an electrical line used for supplying power to the shielding unit 320 and affecting an external apparatus. The filter 321 may be an electromagnetic pulse (EMP) filter configured to cut off electromagnetic pulses.

The pulse signal output by the pulse generating unit 210 may be transmitted to the radiator 226 through the high-power cable 222. According to an exemplary embodiment, the high-power cable 222 may be embodied as a low-loss cable in a frequency range of the pulse signal output by the pulse generating unit 210 (e.g. a frequency range of a pulse signal having a rise time of several ns or less. As shown in FIG. 3, the radiator 226 may have a horn shape such that an opening of a waveguide gradually expands. The radiator 226 may radiate energy toward a predetermined sample 330 disposed in an electromagnetic-wave non-reflection room 300. Meanwhile, the high-power pulse-signal radiation system may further include a support 228 configured to support the radiator 226. A mechanism (e.g., the support 228) disposed near the opening of the radiator 226 may be formed of not a metal but a dielectric material to prevent occurrence of arcs due to peripheral mechanisms around the opening of the radiator 226.

As described above, the operation of the pulse generating unit 210 may be controlled by the remote control unit 230 disposed in a remote place outside the electromagnetic-wave non-reflection room 300. An electric control signal transmitted from the remote control unit 230 may be converted into an optical control signal by the photoelectric conversion unit 240 and transmitted to the pulse generating unit 210 through the optical cable 340. As shown in FIG. 3, the remote control unit 230 may be embodied by a personal computer (PC).

According to an exemplary embodiment, the photoelectric conversion unit 240 may include a universal serial bus (USB)/RS-232 converter 242 and an RS-232/light converter 244. The USB/RS-232 converter 242 may convert the electric control signal, which is transmitted from the remote control unit 230 through a USB, into an RS-232 communication standard signal. The RS-232/light converter 244 may convert the RS-232 communication standard signal into the optical control signal. However, the photoelectric conversion unit 240 may have any other construction to enable conversion of the electric control signal transmitted from the remote control unit 230 into the optical control signal.

### Remote Control Unit

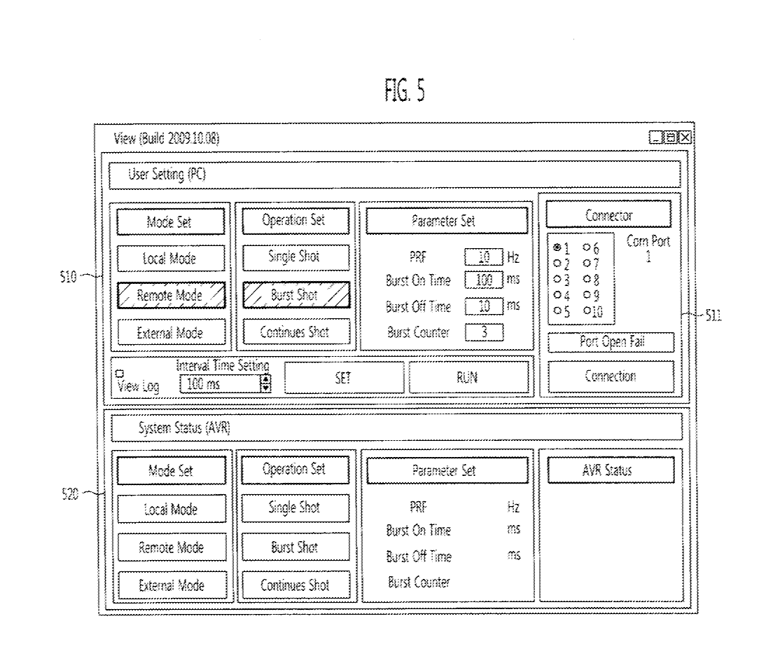

FIG. 4 is a diagram of the remote control unit 230 according to an exemplary embodiment of the present invention.

Referring to FIG. 4, the remote control unit 230 may include a control mode setter 231, an output mode setter 232, a parameter setter 233, a pulse-width modulation setter 234, a communicator 235, and a controller 236. According to an exemplary embodiment, the remote control unit 230 may be embodied by a wired/wireless digital communication apparatus, which may include a memory unit, such as a PC (e.g., a desktop computer or laptop computer), a workstation, a personal digital assistant (PDA), a web pad, a mobile phone, or a navigation system, and a microprocessor (MP) with operation capabilities.

The control mode setter 231 may select a mode of controlling operation of the pulse generating unit 210. The control mode setter 231 may select a “local control mode,” a “remote control mode,” or an “external control mode.” When the “local control mode” is selected, operation of the pulse generating unit 210 may be locally controlled. In the “local control mode,” a user may control the operation of the pulse generating unit 210 through a user interface or keypad provided by the interface provider 214 of the pulse generating unit 210. When the “remote control mode” is selected, the operation of the pulse generating unit 210 may be remote-controlled by the remote control unit 230 spaced far apart from the pulse generating unit 210. In the “remote control mode,” the user may control the operation of the pulse generating unit 210 through the remote control unit 230. In the “local control mode” and “remote control mode,” the entire operation of the pulse generating unit 210 may be controlled. For example, generation and stoppage of pulse signals and waveforms of the generated pulse signals may be controlled. In the “external control mode,” the operation of the pulse generating unit 210 may be controlled in response to an externally applied trigger signal. In the “external control mode,” the pulse generating unit 210 may be controlled in response to the externally applied trigger signal and output a pulse signal in synchronization with the trigger signal. The trigger signal may function as a signal for controlling the operation of a circuit included in the pulse generating unit 210, that is, a circuit configured to convert a power supply voltage and output a pulse signal. For example, the trigger signal may function as a signal for initiating the operation of the circuit included in the pulse generating unit 210. The trigger signal may be a TLL-level square-wave synchronous signal.

The output mode setter 232 may set the waveform of the pulse signal output by the pulse generating unit 210. Modes set by the output mode setter 232 may include a “single output mode,” an “arbitrary output mode.” and a “sequential output mode.” The output mode setter 232 may select one of the modes according to a user's control so that the pulse generating unit 210 can output the pulse signal corresponding to the selected mode. The “single output mode” may be a mode of outputting a single pulse, the “arbitrary output mode” may be a mode of outputting a pulse signal corresponding to a parameter set by a user, and the “sequential output mode” may be a mode of outputting a series of pulse signals according to a set PRF until a stop command is input by the user. When the “sequential output mode” is set, the stop command and the PRF value may be input by the user to the pulse generating unit 210 according to the set control mode or input through the remote control unit 230. That is, the stop command and the PRF value may be input through an interface provided by the interface provider 214 of the pulse generating unit 210 in the “local control mode,” and input through the remote control unit 230 in the “remote control mode.”

The parameter setter 233 may function to set various parameters related with the waveform of the pulse signal output by the pulse generating unit 210. Thus, the parameter setter 233 may set parameters, such as a “PRF,” a “pulse duration time,” a “pulse stop time,” and a “pulse repetition number.” The parameter setter 233 may set parameters of the output signal output by the pulse generating unit 210 according to the user's input when the “arbitrary output mode” is set by the output mode setter 232.

The pulse width modulation setter 234 may control operation of a circuit included in the pulse generator 212 of the pulse generating unit 210 and regulate the width of the pulse signal output by the pulse generating unit 210.

The communicator 235 may enable wired/wireless communication with an external apparatus according to a predetermined communication standard. Although the communicator 235 is a communication module using an RS-232 communication standard, the present invention is not limited thereto and the communicator 235 may be embodied by an ordinary wired/wireless communication module.

The controller 236 may function to control the flow of data among the control mode setter 231, the output mode setter 232, the parameter setter 233, the pulse-width modulation setter 234, and the communicator 235. In other words, the controller 236 according to the present invention may control the control mode setter 231, the output mode setter 232, the parameter setter 233, the pulse-width modulation setter 234, and the communicator 235 to perform intrinsic functions.

Meanwhile, the remote control unit 230 may further include an interface provider (not shown) configured to provide an interface to allow a user to input commands for operating the control mode setter 231, the output mode setter 232, the parameter setter 233, and the pulse width modulation setter 234.

### Examples of Operation of Remote Control Unit

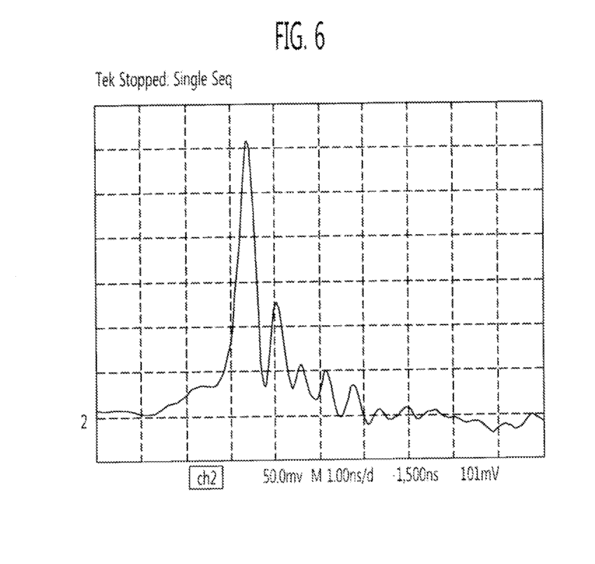

FIG. 5 is a diagram of an example of a user interface provided by the remote control unit 230 according to an exemplary embodiment of the present invention.

Referring to FIG. 5, the user interface provided by the remote control unit 230 may include a user set window 510 and an operation state window 520. The user set window 510 may indicate a state set by a user, and the operation state window 520 may indicate a present operation state of the pulse generating unit 210. Thus, user can set parameters such as PRF, Burst on time, burst off time, burst counter, etc.

In FIG. 6, the user may select a “remote control mode” as a control mode and select an “arbitrary output mode” as an output mode. Also, it is assumed that a “pulse repetition frequency (PRF)” is 10 Hz, a “pulse duration time” is 100 ms, a “pulse stop time” is 10 ms, and a “pulse repetition number” is set to three times. Meanwhile, the user set window 510 may further include a communication state window 511 configured to monitor a state of communication between the remote control unit 230 and the pulse generating unit 210 in real time. The user may confirm the state of communication between the remote control unit 230 and the pulse generating unit 210 through the communication state window 511. Although not described above, the remote control unit 230 may also search for an enabled port of the remote control unit 230 during the communication of the remote control unit 230 with the pulse generating unit 210 and connect the enabled port of the remote control unit 230 with the pulse generating unit 210.

Furthermore, in order to inform the user of the present operation state of the pulse generating unit 210 through the operation state window 520, the remote control unit 230 may call the present set value from the pulse generating unit 210.

Meanwhile, the remote control unit 230 may receive a pulse signal having a divided voltage from the pulse generating unit 210. The remote control unit 230 may display the waveform of the divided pulse signal using an apparatus, such as an oscilloscope. FIG. 6 is a diagram of an example of the waveform of a pulse signal displayed using an oscilloscope.

Thus, the user may confirm the displayed waveform of the pulse signal in real time and monitor the operation state of the pulse generating unit 210 in real time. According to an exemplary embodiment, a voltage of the pulse signal output by the pulse generating unit 210 may be divided into hundredths and transmitted to the remote control unit 230.

### Operation

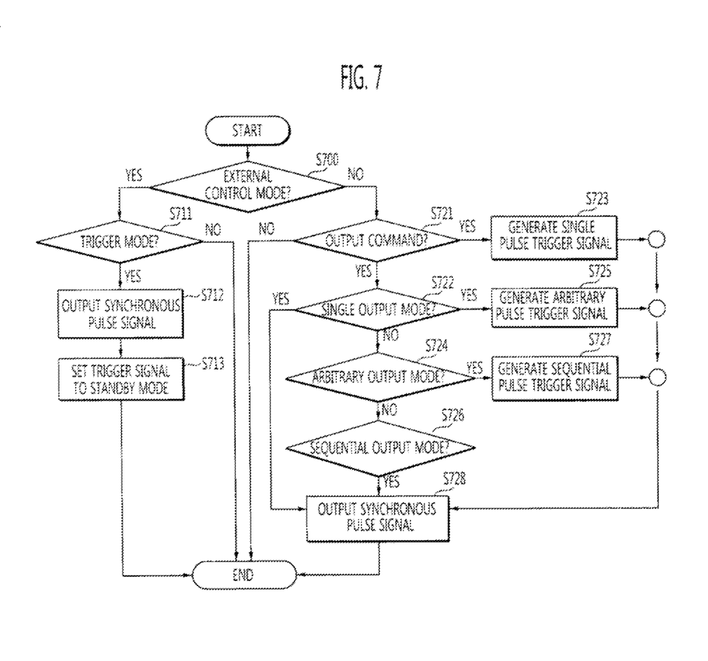

FIG. 7 is a flowchart illustrating a process of controlling the Output of a pulse signal in the pulse generating unit 210 according to an exemplary embodiment of the present invention.

Referring to FIG. 7, it may be determined whether an “external control mode” is selected (S700). As described above, although the “external control mode” may be selected according to a user's input in the remote control unit 230, the “external control mode” may also be selected according to the user's input in the pulse generating unit 210.

When it is determined that the “external control mode” is selected, a pulse signal synchronized with an externally applied trigger signal may be output. Specifically, after a “trigger signal mode” is set (S711), the pulse signal synchronized with the externally applied trigger signal may be output as an output signal (S712). As described above, the trigger signal may be used as a signal for initializing the operation of the circuit included in the pulse generator 212 of the pulse generating unit 210. Thus, the pulse signal synchronized with the trigger signal may be output. After the pulse signal is output, the trigger signal may be set to a standby mode (S713).

Meanwhile, when it is determined that the “external control mode” is not selected, it may be determined whether a command to output the pulse signal is currently input (S721). To determine whether the command to output the pulse signal is currently input, it may be confirmed whether a user inputs an execution command to the remote control unit 230 or the pulse generating unit 210. According to an exemplary embodiment, when the user inputs an “execution” command through a keypad prepared in the pulse generating unit 210, it may be determined that the command to output the pulse signal is input. When it is determined that the command to output the pulse signal is not input, a process of controlling the output of the pulse signal may be ended, and when it is determined that the command to output the pulse signal is input, the output pulse signal may be used as the trigger signal according to an output mode selected by the user. Although the output mode is selected by the remote control unit 230 as described above, the output mode may be selected by the pulse generating unit 210. A process of generating the trigger signal according to the output mode will now be described. After it is determined whether a “single output mode” is selected (S722), when it is determined that the “single output mode” is selected, a single pulse signal may be output and used as a trigger signal (S723). When it is determined that the “single output mode” is not selected, it may be determined whether an “arbitrary output mode” is selected (S724). Thus, when it is determined that the “arbitrary output mode” is selected, a pulse signal having a parameter set by the user may be output as the trigger signal (S725). Also, when it is determined that the “arbitrary output mode” is not selected, it may be determined whether a “sequential output mode” is selected (S726). Thus, when it is determined that the “sequential output mode” is selected, the pulse signal may be output as the trigger signal according to a set PRF until the user issues a stop command (S727). Although FIG. 7 exemplarily illustrates that the “single output mode.” the “arbitrary output mode,” and the “sequential output mode” are sequentially selected, output modes may be selected in any other order.

The trigger signal output in each mode may be used as a signal for controlling operation of the circuit included in the pulse generator 212 of the pulse generating unit 210, and the pulse generating unit 210 may output a pulse signal in synchronization with the trigger signal (S728).

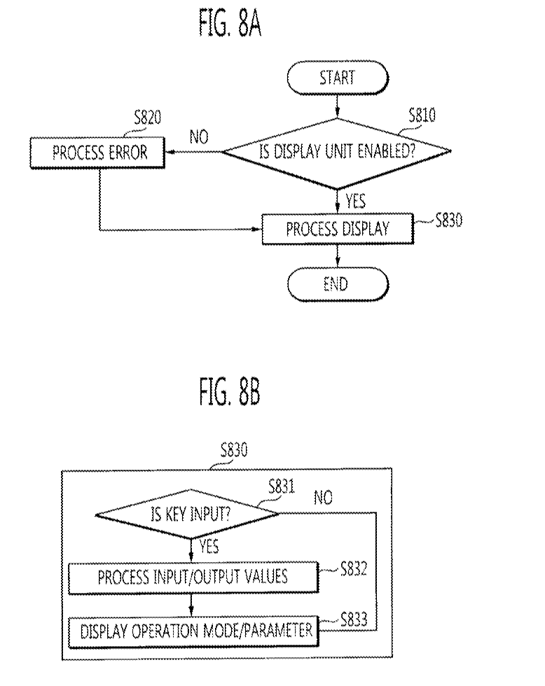

FIG. 8A is a flowchart of operation of a display unit included in the pulse generating unit 210.

Referring to FIG. 8A, initially, it may be determined whether the display unit is enabled (S810). When the display unit is not enabled, an error processing operation may be performed (S820), and a display processing operation may be performed (S830). The error processing operation may include removing errors and putting the display unit into an enabled state.

When it is determined that the display unit is enabled, the display processing operation may be immediately performed (S830).

FIG. 8B is a flowchart of the display processing operation (S830).

Referring to FIG. 8B, it may be determined whether a command is input by the user. According to an exemplary embodiment, it may be determined whether a key included in the keypad included in the pulse generating unit 210 is input by the user (S831). When it is determined that the key is input, an input/output value processing operation may be performed (S832), and a currently set operation mode or parameter may be displayed (S833). The input/output value processing operation may be a general purpose input/output (GPIO) processing operation.

When it is determined that the key is not input by the user, the current operation mode or parameter may be immediately displayed (S833).

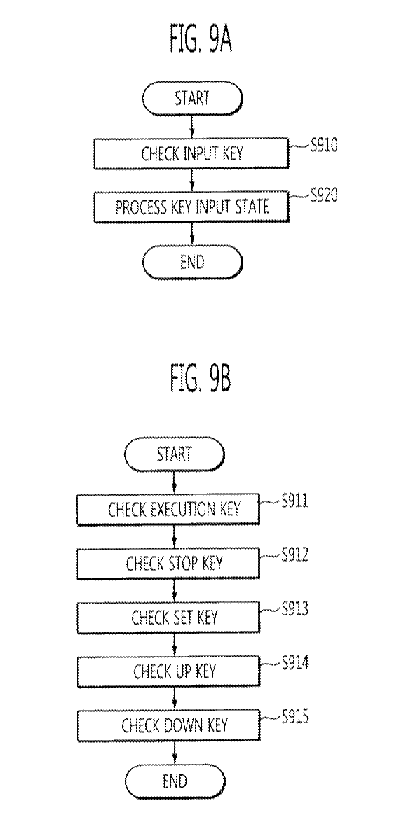

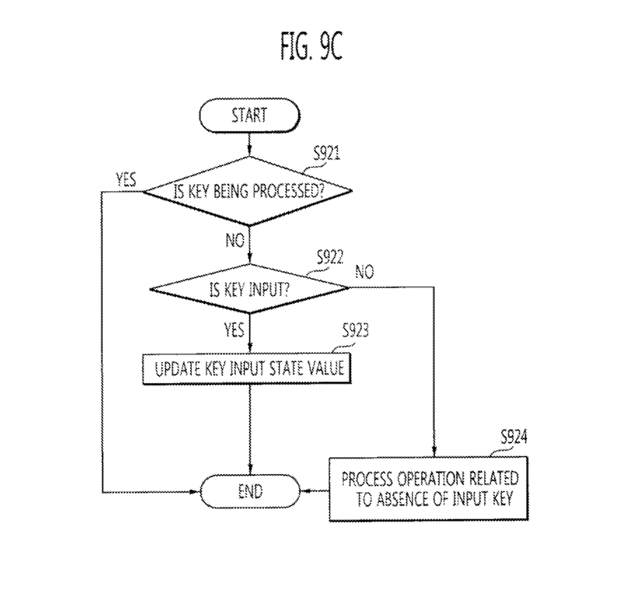

FIG. 9A is a flowchart of an operation (S832 of FIG. 8B) of processing input/output values.

Referring to FIG. 9A, wholly input keys may be checked (S910), and then states related to the input keys may be processed (S920).

FIG. 9B is a flowchart of the key check operation (S910).

Referring to FIG. 9B, it may be sequentially checked whether “execution,” “stop.” “set.” “up.” and “down” keys are input by the user (S911 through S915). The order in which the keys are checked may be varied without limit, and other kinds of keys than shown in FIG. 9B may be further included.

FIG. 9C is a flowchart of an operation (S920) of processing a key input state.

Referring to FIG. 9C, it may be determined whether an operation corresponding to a key input by the user is being processed (S921). Thus, when the operation corresponding to the input key is being processed, the entire process may be ended, and when the operation corresponding to the input key is not being processed, it may be determined whether a new key is input (S922). When it is determined that the new key is input, a key input state value may be updated (S923). When it is determined that the new key is not input, an operation related to the absence of the input keys may be processed (S924).

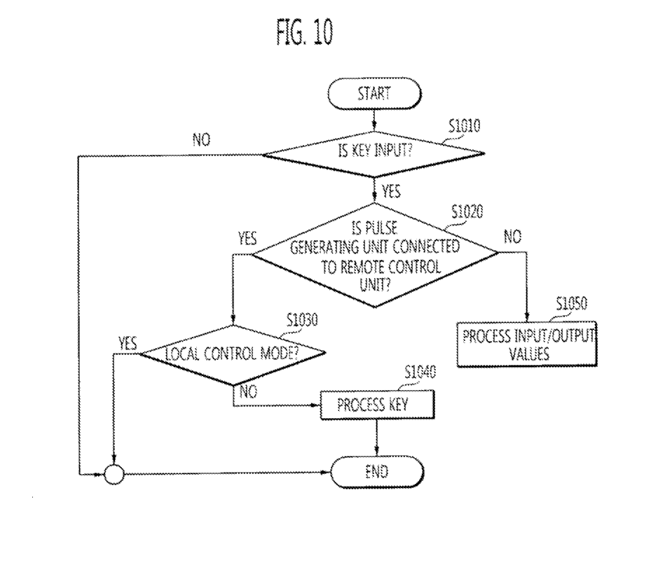

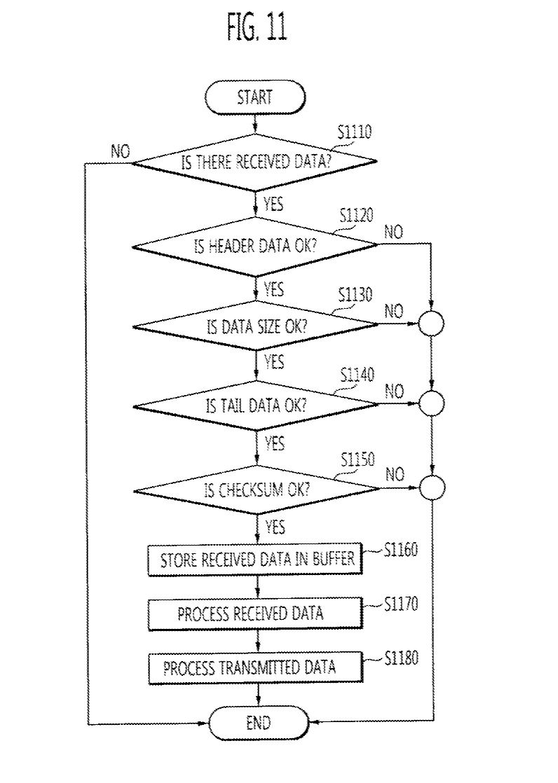

FIG. 10 is a flowchart of a process of performing an operation corresponding to the input key in the display unit included in the pulse generating unit.

Referring to FIG. 10, it may be determined whether the key is input (S1010), and it may be determined whether the pulse generating unit 210 is connected to the remote control unit 230 (S1020). When the pulse generating unit 210 is connected to the remote control unit 230, it may be determined whether the remote control unit 230 is set to a “local control mode” (S1030). When the remote control unit 230 is set to the “local control mode,” the entire process may be ended. When the remote control unit 230 is not set to the “local control mode,” an operation corresponding to the input key in the remote control unit 230 may be performed (S1040). Meanwhile, when it is determined that the pulse generating unit 210 is not connected to the remote control unit 230, an input/output value processing operation may be performed in the pulse generating unit 210 (S1050). Operation S1050 may be the same as operation 5832 of FIG. 8B.

FIG. 11 is a flowchart of a process of controlling communication between the pulse generating unit and the remote control unit.

Referring to FIG. 11, it may be determined whether there is data received from the remote control unit 230 (S1110). When there is no received data, the entire process may be ended, and when there is received data, it may be determined whether header data is in a normal state (S1120), whether data size is within a normal or permitted range (S1130), whether tail data is in a normal state (S1140), and whether a checksum stored in the header data is in a normal state (S1150). The order in which the determinations are made may be varied without limit. When even one determination result is not in the normal state, the entire process may be ended. When all the determination results are in the normal state, the received data may be stored in a buffer (S1160) and processed (S1170). Thereafter, when there is data to be transmitted, the data may also be transmitted (S1180).

According to the present invention, a pulse signal may be precisely output based on desired parameters, and a user may be safely protected from high electric-field-intensity environments.

In the drawings and specification, there have been disclosed typical exemplary embodiments of the invention and, although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A high-power pulse-signal radiation system comprising:
a pulse generating unit configured to generate a pulse signal using a power supply voltage, and transmit the pulse signal to a radiation unit through coaxial high power cable;
a pulse radiation unit configured to receive the pulse signal generated by the pulse generating unit and radiate pulse energy corresponding to the pulse signal in a space;
a remote control unit configured to transmit an electric control signal required for controlling operation of the pulse generating unit; and
a photoelectric conversion unit configured to convert the electric control signal transmitted from the remote control unit into an optical control signal and transmit the optical control signal to the pulse generating unit,
wherein the pulse generating unit comprises a capacitive divider circuit inherently to monitor a state of the pulse generating unit in real time.

2. The system of claim 1, wherein the remote control unit comprises:
a control mode selector configured to select a mode of controlling the pulse generating unit;
an output mode setter configured to set a waveform of the pulse signal generated by the pulse generating unit;
a parameter setter configured to set parameters related with the waveform of the pulse signal output from the pulse generating unit;
a pulse width modulation setter configured to control a width of the pulse signal output from the pulse generating unit.

3. The system of claim 2, wherein the control mode selector selects one of a local control mode in which the pulse generating unit is locally controlled, a remote control mode in which the pulse generating unit is remote-controlled by the remote control unit, and an external control mode in which the pulse generating unit is controlled in response to an externally applied trigger signal and outputs a pulse signal in synchronization with the trigger signal according to a user's input.

4. The system of claim 2, wherein the output mode setter selects one of a single output mode in which the pulse generating unit outputs a single pulse signal, an arbitrary output mode in which the pulse generating unit outputs a pulse signal corresponding to a parameter set by a user, and a sequential output mode in which the pulse generating unit outputs a series of pulse signals according to a set pulse repetition frequency (PRF) until a stop command is input, according to a user's input.

5. The system of claim 4, wherein the remote control unit further comprises a parameter setter configured to set the parameter of the pulse signal output by the pulse generating unit according to the user's input when the arbitrary output mode is selected by the output mode setter.

6. The system of claim 5, wherein the parameter includes at least one selected from the group consisting of a PRF, a pulse duration time, a pulse stop time, and a pulse repetition number.

7. The system of claim 1, wherein the remote control unit displays the divided pulse signal using an oscilloscope in real time.

8. The system of claim 1, wherein the pulse generating unit comprises:
a pulse generator configured to receive the power supply voltage and generate the pulse signal; and
an interface provider configured to provide an interface that allows a user to input a control command to control the operation of the pulse generator.

9. The system of claim 1, wherein the pulse generating unit displays an operation state of the pulse generating unit and a state of communication between the pulse generating unit and the remote control unit in real time.

10. The system of claim 1, wherein the pulse radiation unit comprises:
a radiator configured to radiate the pulse energy; and
an urgent transmitter configured to urgently transmit the pulse signal generated by the pulse generating unit to the radiator.

11. The system of claim 10, wherein the radiator includes a horn antenna in which an end of a waveguide expands in a trumpet shape.

12. The system of claim 1, wherein the pulse generating unit and the pulse radiation unit are contained in an electromagnetic-wave non-reflection room having an inner wall on which an absorbing material capable of minimizing electromagnetic scattering characteristics is formed, and the pulse generating unit is contained in a shielding rack configured to cut off electromagnetic waves.
